(19) United States
(12) Patent Application Publication
(10) Pub. No.: US 2011/0137516 A1
(43) Pub. Date: Jun. 9, 2011

(54) DEVICE FOR MONITORING WASTAGE ON AUTOMOTIVE SUSPENSION

(76) Inventors: Narciso Ichano, JR., Limeira-Sao Paulo (BR); Nilton Tadeu Duräes, Mogi Mirim-Sao Paulo (BR)

(21) Appl. No.: 12/523,080

(22) PCT Filed: Dec. 14, 2007
(86) PCT No.: PCT/BR07/00364

§ 371 Date: Nov. 17, 2009

(30) Foreign Application Priority Data
Jan. 15, 2007 (BR) PI 0700362-5

(51) Int. Cl. G06F 19/00

(52) U.S. Cl. 701/30

(57) ABSTRACT

Device for monitoring wastage on automotive suspension (slm). New device, to be applied on automotive suspension in general. Such allows monitoring of components of the suspension, concerning their lifetime, providing the user an exact verification of the state of each component, thus allowing that they may be checked and replaced before it gets damaged. This device provides a preventive maintenance, offering greater safety for the vehicle and its occupants.

This application concerns the detailed description, followed by detailed illustrations, of a new device to be applied on automotive suspensions in general, which allows monitoring the components of the suspension regarding their lifetime, allowing the user to verify exactly the state of each component, allowing it to be checked and replaced before the component gets damaged. This device allows preventive maintenance, thus offering more safety for the vehicle and its users.

Measuring the durability of components which constitute the system of an automotive suspension, be it by estimating the mileage ran by the vehicle or through visual verification, is not always is an easy task. Even though the lifetime of such components is estimated by the quantity of kilometers already ran by the vehicle, such measurement does not consider important variables to the lifetime of a suspension, such as: pavement characteristics, the speed of the vehicle, adverse conditions of driving, weather and road, etc. On the other hand, if the verification of such components is visual, noticing a problem on a specific component can only be checked after it is already damaged, therefore allowing a corrective but not a preventive action of maintenance, what may cause later accidents and/or serious problems;

The best way of measuring the lifetime of a component of the suspension is measuring the work already performed by the suspension, through the monitoring of cycles of suspension action, what is the purpose of the here presented device.

Some relevant patents concerning the constitutive components of the suspension system of a vehicle and its ways of being monitored are below mentioned.

A PI-9905069-2, describes a hydraulic shock absorber for vehicles, particularly applicable to the rear suspension of automotive vehicles, consisting of a tubular body in flexible and impermeable material (10), filled with a viscous fluid (fv), having a first and a second extreme axial wall (11,12) and relatively moveable between itself; a first support (mean) mounted on one of the suspended and non-suspended masses of the vehicle, against which is fixed the first extreme wall (11) of the tubular body (10); a cylindrical reservoir (40), rigid, hermetically-sealed, containing highly-pressurized gas, having one extreme external wall (41), fixed on other of the suspended and non-suspended masses and an internal way (42) opposed to the first one and constituting a second mean of support (50) against which is fixed the second extreme wall (12) of the tubular body (10); and valve means provided on the internal extreme wall (42) of the reservoir (40), establishing a fluid communication selective and restrict between the tubular body (10) and the reservoir (40) while the suspension of the vehicle is moving.

A PI-0000929-6 describes a mechanical system for detection of mechanical defects on the suspension of an automotive vehicle of movement through eccentric axis. Its chassis-platform (1) is made of steel profiles, presenting itself on a monoblock system with all parts forming a single volume or with one of each moveable bearers (2) separated for installation on site, or disposed according to the adjust for distance between axis (3) and moved by articulate arms (4) and levers (5), which are attached to the stirrings wheels of the eccentric axis (6) by the eccentric axis (7) and, to the same are attached reductors (8) with reductor engines (9) and speed variators (10), which are linked to the panel of control and command of movements (11), which are upon the mobile bases (12) which have engines to regulate the amplitude of the course of the bearers (13); linked to the suspension axis of the wheels of the automotive vehicles, we see the sensors of vibration and noise (14), and linked to the mobile bearers (2) we have the vertical movement sensors (15), and at last the visualization panel (16). Such system allows to detect the defects of the suspension of an automotive vehicle; and

PI-0102109-5 describes a hydraulic circuit and apparel for controlling the suspension of a vehicle; a hydraulic circuit controls a double-action cylinder of the suspension of a vehicle, allowing balancing functions of charge and shock absorbing. A solenoid valve unit controls the application of pressurized hydraulic fluid from the supply line to the cylinder and from the cylinder to the tank return line, thus lifting and lowering the vehicle for charge balancing. The cylinder chambers are interconnected through a parallel set of a retention set, an orifice and an escape vale, and another parallel set of the retention vale, an orifice and an escape vale links the cylinder to an accumulator. These components set in parallel allow the Double-action cylinder to perform as a passive shock absorber. A blockage valve is disposed in a preferred way to annulated the operation of shock absorbing and to providing a very rigid suspension.

Therefore, it can be noted that a specific device to be applied to the automotive suspension in general does not exist specially for passenger vehicles, and which allows monitoring the components of the suspension regarding their lifetime.

On such way, for treating itself of the only way of effectively measuring the lifetime of the components of the automotive suspension, no other device or system similar to the ones presented on this patent application was found to be possible to mention or make any correlation with the State of Art.

Commercially, the lifetime of the components for automotive suspension is estimated on the basis of distance ran by the vehicle, which reference is not effective as it disconsiders important conditions of suspension work. Parting from this premise, it is necessary a device that is capable of estimating the lifetime of suspension components based on the work performed by the suspension, through the number of its cycles of action.

Having in mind the necessity of having a device that can control and monitor in preventive effective form and efficient way the lifetime of the components of the suspension system of the automotive vehicles, that was researched and idealized the DEVICE FOR MONITORING THE WASTAGE OF AUTOMOTIVE SUSPENSION (SLM), object of the present patent.

Next, it is made reference to the figures which follow this descriptive application, for the better understanding and illustration of it, where it can be seen:

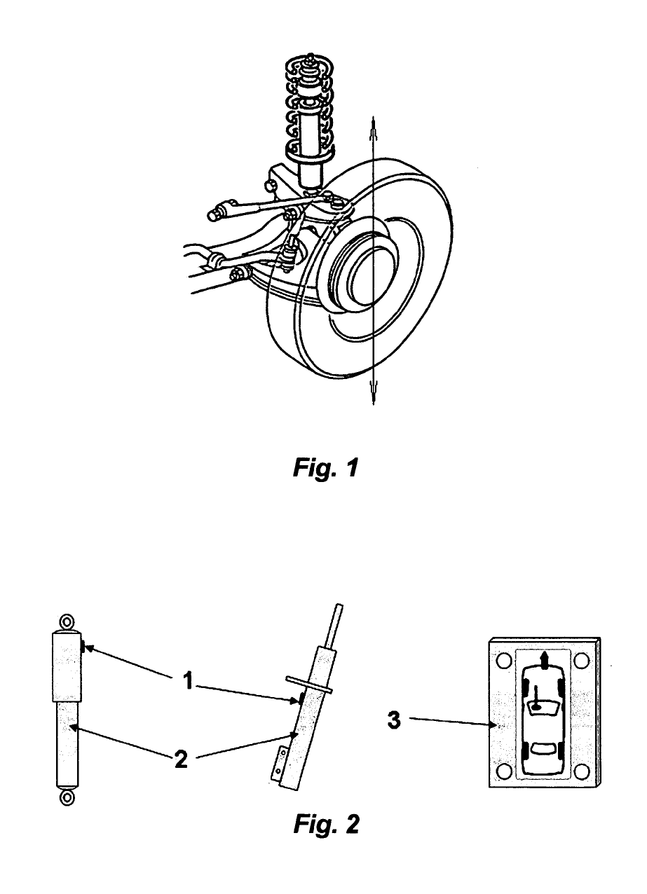

FIG. 1 shows a scheme of the articulation of the suspension of an automotive vehicle.

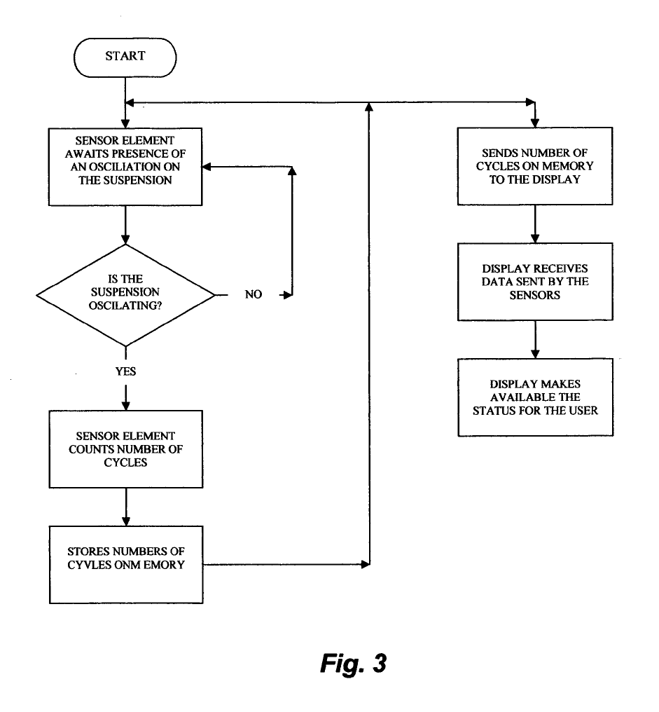

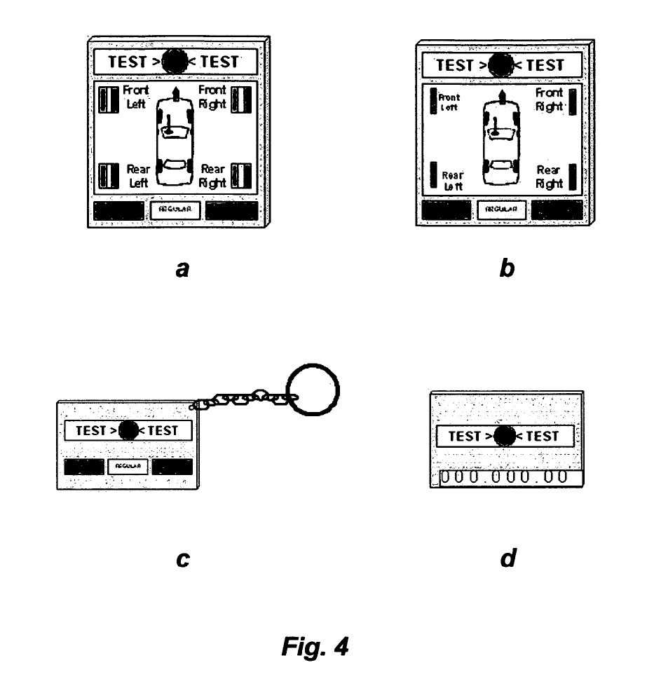

FIG. 2 shows a scheme of the Device for Monitoring the wastage of the Automotive Suspension, object of the present patent, highlighting its main components and disposition forms. FIG. 3 illustrates the diagram of working blocs of the device for monitoring wastage on automotive suspension, object of the present application.

FIG. 3 shows some schematic models of display variations that can be used with the device for Monitoring the Wastage of Automotive Suspension, being a) Display with traffic light-like status indicator for each suspension, being b) Display with indication of status of the single traffic light kind and four sequential position indicators; c) Display with indication of status of single traffic-light kind; and d) Display with status indication of the single digital kind.

Next, it is described the preferential, but non-restrictive, form of performing of the present Device of Monitoring Wastage of the Automotive Suspension, object of the patent, where the configuration and application may vary on adequate form for each desired model; describing one of the constructive possibilities that lead the concretization of the described object and the form in which it performs.

The Device of Monitoring the Wastage of Automotive Suspension, or simply “SLM”, object of the present patent, consists of an electro-electronic device, disposed strategically beneath the suspension of the vehicle, which monitors the number of relevant cycles, which are the action of the suspension in function of the irregularities presented by the pavement in general, which effectively may cause damage to the suspension components. Wherein, this information is made available to the vehicle conductor, informing when the replacement of a component is recommended.

The Device of Monitoring the Wastage of Automotive Suspension in its whole is constituted by sensors and a display. For measuring the cycles of work a suspension, the sensor (1) can be mounted on the shock absorber (2), or in any other place of the suspension in which it can be possible to monitor such disturbance on each set of suspension of the vehicle (of the totaling four).

The measurements performed by the sensors are transmitted to the display (3), which be placed on visible place in the vehicle, thus informing the conductor the current situation of each suspension. Therefore, according to the number of cycles, the display will indicate which pieces should be inspected and/or preventively replaced.

The measurement performed by this device is only of informative character, based on the number of cycles of action of the suspension and not in the current condition of each suspension component, serving the user of an exact benchmark on the state and lifetime of the components of the suspension, providing a preventive maintenance of them.

As described above, the Device for Monitoring the Wastage of Automotive Suspension, here presented, is constituted by two main parts, being the sensor element (1). four being required, one for each wheel suspension-, and a display (3). Therefore, for explaining and illustrating the functioning, it is made the description of only one sensor, as the other sensors operate in the same form, together and simultaneously.

The system of automotive suspension works with the intention of filtering the imperfections offered by irregular ground, diminishing as less as possible the effects felt by both the occupants and the chassis of the vehicle.

To perform such function, the suspension works oscillating downwards and upwards, following the irregularities that each Wheel is exposed to, as illustrated on FIG. 1. This work is possible to be performed by the suspension only because of the articulation allowed between the parts which move together with the wheel. The working principle of the Device for Monitoring the Wastage of Automotive Suspension (SLM), here presented, consists in the installation of the mentioned sensor element on one of the pieces that suffer such movement with the work of the suspension, being recommendable the installation of the sensors on the shock absorbers (2) of the vehicles, since they are the ones which offer better conditions for installation, as well as they offer greater course of movement without offering interference to the functioning of the other components. As the suspension oscillates, the sensor element detects these movements, called “cycles”, and counts them through an electronic internal circuit as pulses. As such pulses are contacts, the total number of cycles is sent to the display, which should be positioned preferably inside the vehicle, and will indicate through stages or digits the current situation of the suspension to the user.

Many kinds of sensors can be used in this device. We can cite as an example the most adequate ones found in market, non-restrictive to the functioning of the device as whole, such as: the Piezoelectric sensors, the Sphere sensors, the Electrets sensors, the Flexible Spring in metallic tube sensors, and the Flexible Spring in Plastic Tube sensors. Also, many models of displays can be used, the ones, in keychain shape or any other arrangement. As examples of non-restrictive displays, we can cite the displays with of traffic lights-like status indicator for each suspension, the display with single traffic light indicator and four (sequential) position indicators, in which the traffic light kind indicators can be formed by three light-emitting diodes (LEDs) in the green, yellow and red colors, or a single LED with three-color capabilities.

This Device for Monitoring the Wastage of Automotive Suspension, object of this present application, as presented in its characteristics of configuration and functioning, measures the number of relevant cycles of the movement of the suspension of an automotive vehicle, which represent the real work of the suspension of the vehicle, which benchmarks make possible estimating the remaining lifetime of each suspension component, allowing a trustworthy preventive maintenance.

Compared with the reference used today commercially, which is based on the mileage of the vehicle, this device is much more efficient as it has as working principle the measurement of the relevant cycles of work of the suspension.

Therefore, for the aforementioned characteristics of configuration and functioning, it can be clearly noted that the Device for Monitoring the Wastage of Automotive Suspension (SLM) is an innovative and unique equipment for the State of Art, being covered by conditions of innovation, inventive activity and unpublished industrialization, thus making it deserve the Privilege of patent of Invention.

1. DEVICE FOR MONITORING WASTAGE ON AUTOMOTIVE SUSPENSION (SLM). Characterized as an electro-electronic device, strategically disposed inside the suspension of the vehicle, monitoring the number of relevant cycles, which are the action of the suspension as conditioned by the irregularities presented by the track in general, which effectively may cause any damage to the suspension components; such information is available for the vehicle conductor, informing when the replacement of a component is recommended.

2. DEVICE FOR MONITORING WASTAGE ON AUTOMOTIVE SUSPENSION (SLM), according to claim 1, characterized by the device for monitoring wastage on automotive suspension being constituted by sensors and a display, where the sensor (1) may be mounted on the shock absorber (2) or any other place of the suspension in which it is possible to monitor such disturbances on each set of suspension of the vehicle, totaling at least four sensors, where all the measurements performed are transmitted to the display (3), which will be disposed on visible place in the vehicle, informing its user the current situation of each suspension, where according to the number of cycles, the display should indicate which pieces should be inspected and/or replaced preventively.

3. DEVICE FOR MONITORING WASTAGE ON AUTOMOTIVE SUSPENSION (SLM), according to claims 1 and 2, characterized by the possibility of sensors being of many models, non-restrictive to the functioning of the device, such as: Piezoelectric sensors, Sphere sensors, Electrets sensors, Flexible Spring in Metallic tube sensors, and Flexible Spring on a Plastic Tube sensors.

4. DEVICE FOR MONITORING WASTAGE ON AUTOMOTIVE SUSPENSION (SLM), according to claims 1 and 2, characterized by possibility of the displays being of several non-restrictive to the device models, such as being in the keychain form or any other disposition, such as: the Display with light-traffics, three-stage indicator for each suspension; Display with status indication of the single traffic light kind and four position indicators; where the traffic light indicators can be constituting of three light-emitting diodes (LEDs) in the red, yellow and green colors, or by a single LED with three-color capabilities.
